(19) United States
(12) Patent Application Publication
(10) Pub. No.: US 2024/0242152 A1
(43) Pub. Date: Jul. 18, 2024

(54) IN-TIME AVIATION SAFETY MANAGEMENT SYSTEM FOR MONITORING AND MITIGATING ADVERSE OR OFF-NOMINAL CONDITIONS IN AN AVIATION ECOSYSTEM

(71) Applicant: ResilienX, Inc., Syracuse, NY (US)

(72) Inventors: Andrew Carter, Liverpool, NY (US); Greg Dorchies, Jericho, VT (US); Ryan Pleskach, Liverpool, NY (US); Matt Synborski, Erieville, NY (US)

(21) Appl. No.: 18/201,543

(22) Filed: May 24, 2023

Related U.S. Application Data
(60) Provisional application No. 63/438,652, filed on Jan. 12, 2023.

(51) Int. Cl. G06Q 10/0635

(52) U.S. Cl. CPC G06Q 10/0635

(57) ABSTRACT

A system, methodology, and computer program identified herein as an in-time aviation safety management system (LASMS) configured to monitor an aviation ecosystem for adverse or off-nominal conditions. Once detected, the IASMS assesses the potential impact of the condition. Finally, the LASMS mitigates the condition using both built-in automated mitigations and third-party registered mitigations.

### CROSS-REFERENCE TO RELATED APPLICATIONS

The present application claims priority to and the benefit of U.S. provisional patent application Ser. No. 63/438,652, filed Jan. 12, 2023, the contents of applications being incorporated herein by reference in their entireties

### BACKGROUND

The present invention relates to a system and methodology for establishing safety assurance solutions for highly automated and autonomous ecosystems.

### SUMMARY OF THE INVENTION

In illustrative embodiments, a system, methodology, and computer product for providing real-time or in-time safety assurance solutions for highly automated and autonomous ecosystems is provided. The system, methodology, and computer product monitor the heath, integrity, and performance of the systems involved in uncrewed aircraft systems (UAS) operations, enabling organizations to meet the FAA's considerations around associated elements (i.e., . . . in-service monitoring criteria to detect out-of-compliance performance and initiate corrective action . . . ).

In illustrative embodiments, the system, methodology, and computer program identified herein as an in-time aviation safety management system (IASMS) that can be configured to monitor an aviation ecosystem for adverse or off-nominal conditions. Once detected, the IASMS assesses the potential impact of the condition. Finally, the IASMS mitigates the condition using both built-in mitigations, or third-party registered (via configuration or application programming interface (API)) mitigations. Third-party mitigations are provided by the third-party and configured with the IASMS at deployment or initial set-up. Mitigations may be automated or involve a human-in-the-loop.

The IASMS monitors for conditions over various time horizons including near real-time detection as well as precursor, anomaly, and trend (PAT) detection over time.

The IASMS monitors the health, integrity, and performance of systems and data in the ecosystem where failure or degradation poses a safety risk and are therefore deemed “safety critical.”

The IASMS system architecture includes individual advanced algorithms, functions, or services within that architecture having application over various technologies and provides a platform (e.g., a computer program product) which may be implemented over a variety of real-world environments. As an example, an algorithm for detecting the latency associated with data between systems includes comparing various send and receipt timestamps against time of applicability. The calculated latency is then compared against a threshold which may be preconfigured or adjusted over time based on the live characteristics. Latency which breaks this threshold is then passed through a configurable M of N filter to determine if an alert or mitigation should be generated.

In illustrative embodiments, the architecture of the system, methodology, and computer product of the present invention includes a foundation incorporating individual advanced algorithms, functions, and/or services within various applications or modules. The IASMS, methodology, and computer program product platform may be applied and/or utilized in a variety of real-world environments and applications. Moreover, the IASMS, methodology, and computer program product platform may be specifically configured or adapted to any real world environment or third-party user thereby addressing the needs and parameters unique to a third-party user. This configuration takes place via a process that reads in and distributes configuration parameters to the various algorithms, functions, and services which use them. This configuration process takes place at startup and can be re-run at any time resulting in a runtime configurable system. No pause in service to restart or re-configure is required to update any configuration parameter within the IASMS. Access to the configuration and re-load functions are access controlled for security. The IASMS prevents cases where the configuration contains errors by performing its own set of information validation checks during the configuration process.

### BRIEF DESCRIPTION OF THE DRAWINGS

The features of the application can be better understood with reference to the drawings described below, and the claims. The drawings are not necessarily to scale; emphasis instead generally being placed upon illustrating the principles described herein. In the drawings, like numerals are used to indicate like parts throughout the various views.

FIG. 1 illustrates one exemplary embodiment of the functional architecture included in the system, methodology, and computer-program product in accordance with one or more illustrative embodiments of the present invention.

FIG. 2 is a diagram illustrating the various representative systems associated with the functional architecture of the system, methodology, and computer-program product in accordance with one or more illustrative embodiments of the present invention.

FIG. 3 is a flow chart illustrating determining relationship functions associated with data collected by the system, methodology, and computer-program product in accordance with one or more illustrative embodiments of the present invention.

FIG. 4 is a block diagram illustrating integrity monitoring functionality of the functional architecture in accordance with the system, methodology, and computer-program product in accordance with one or more illustrative embodiments of the present invention.

FIG. 5 is a flow chart illustrating the methodology of implementing the system, methodology, and computer-program product in accordance with one or more illustrative embodiments of the present invention.

FIG. 6 illustrates an exemplary embodiment of a computing system in accordance with one or more illustrative embodiments of the present invention.

FIG. 7 illustrates a distributed communications/computing network in accordance with which one or more embodiments of the present disclosure can be implemented.

### DETAILED DESCRIPTION OF THE INVENTION

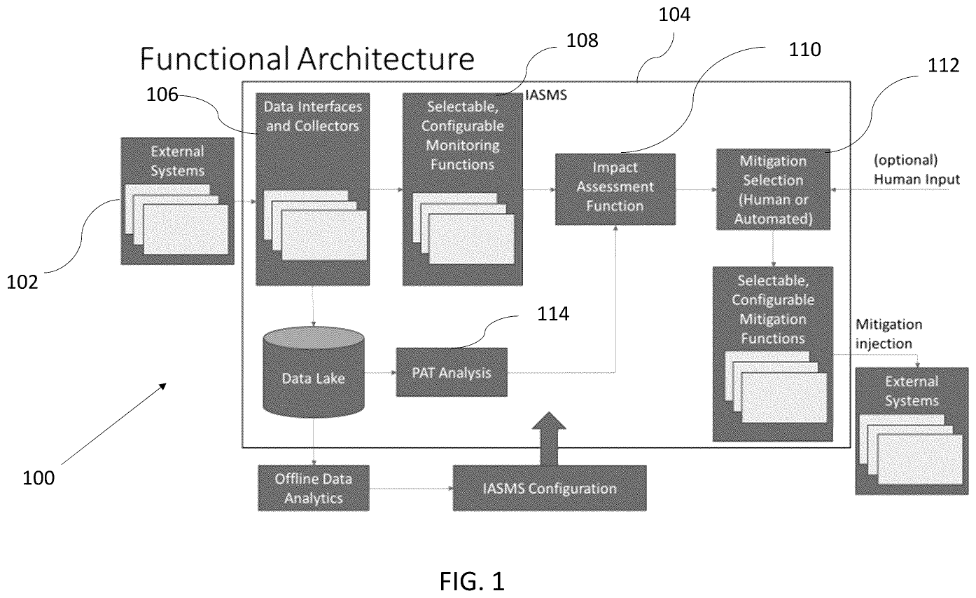

FIG. 1 illustrates one exemplary embodiment of the functional architecture 100 included in the system, methodology, and computer-program product in accordance with the principles of the present invention. The framework 100 utilizes external systems 102 which include any systems or data with which the IASMS 104 integrates. The IASMS 104 communicates with all manner of Associated Elements (this is an FAA-defined term and described hereinbelow), meaning any system or data used in a UAS operation which is not physically flying on the craft. A listing of external systems 102 includes at least: 1) communications systems; 2) surveillance systems; 3) navigation systems and aids; 4) weather sensing systems; and 5) digital infrastructure systems such as UAS Traffic Management Service Suppliers (USS) or Flow Control.

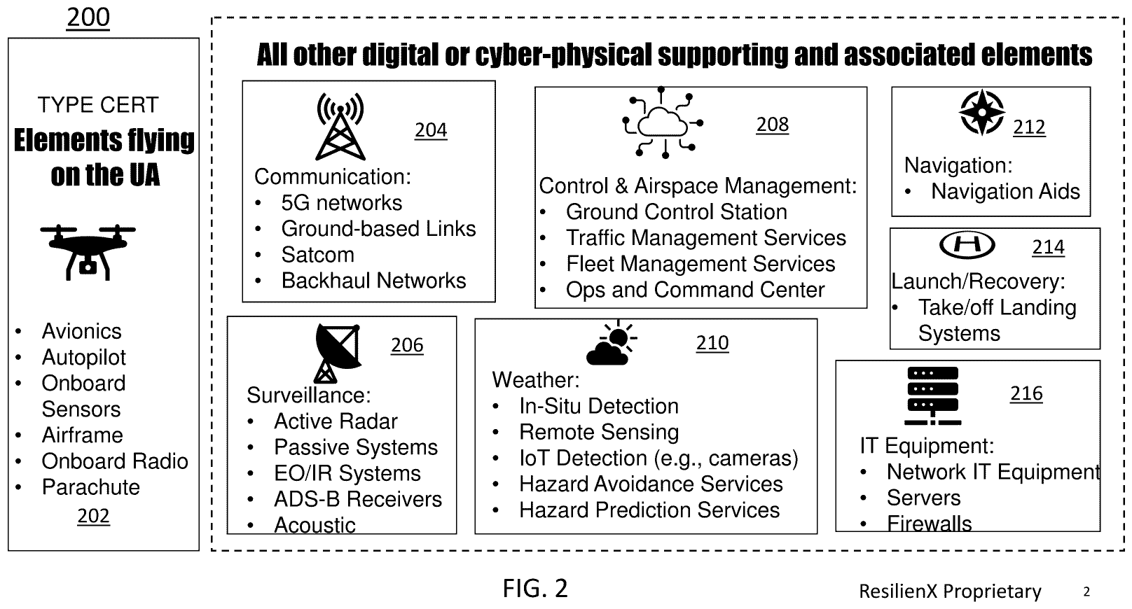

FIG. 2 illustrates an architecture 200 of various sensors and equipment associated with the Unmanned Aircraft (UA) or Unmanned Vehicle and the framework 100. The architecture includes the Type Certification 202 including the design of the Unmanned Aircraft (UA) or Unmanned Vehicle and the component parts associated therewith, the Communication Network 204, the Surveillance Network 206, the Control and Airspace Management Network 208, the Weather Network 210, Navigation Aids 212, Launch/Recovery Systems 214 and IT Equipment 216. The IASMS 104 may also monitor onboard systems and components of the craft through data passed down to the ground control system or made available on the terrestrial network (not a direct link to the craft/UAS). An incomplete list of these external systems 102 includes 1) parachute systems; 2) DAA systems; 3) sensors; 4) navigation systems; 5) precision landing systems; and communication systems. Data collected from these onboard systems may include self-reported health, faults, temperature, voltage, configuration, and the like. Referring again to FIG. 1, the IASMS 104 includes a data interface and collector module 106. The external systems produce data using all manner of interface types and data descriptions. Data may be streamed over any conventional internet-based protocol including, without limitation, user datagram protocol (UDP), a web-socket or API interface, or may even come through a middleware protocol such as Data Distribution System (DDS). Data from different types of external systems could contain meteorological information, surveillance target details, self-reported status, and the like. These data are described and processed very differently from each other.

The IASMS must interface with systems comprised of message passing interfaces, such as a system with a network interface, either on a closed network or over the internet, and therefore is able to talk many different languages over many different interface types. Interface types may include UDP data streams, RESTFul APIs, AMQP, MQTT, WebSocket, and the like. Authentication protocols (ex. OAuth2.0) may also vary by data stream or even amongst different vendors using the same interface type.

The data interfaces and collector module 106 is a collection of functions which can communicate with external systems. Different deployments of an IASMS may talk to different system types and therefore these interfaces are selectable on a by-deployment basis, based on the available systems, configuration, and data for that deployment. These data interfaces convert data to a standardized internal format for processing. Internal formats are divided by logical domain (e.g., surveillance, telemetry, weather, etc.).

The IASMS module 104 includes a monitoring module 108. Because the systems and data may differ from deployment to deployment depending on the needs of third-party user(s), the monitoring module 108 enables the IASMS module 104 to select monitoring functions which are appropriate for the systems and data available on a per-deployment basis, determined during deployment and configuration. Moreover, the ecosystem may behave differently, even if it is using similar systems due to configuration, environment, requirements, etc. This necessitates the need for the monitoring module(s) 108 to be configurable to manage deployment uniqueness. More specifically, the flexibility to configure the monitoring module 108 and other components of the system 100 to handle factors, parameters, etc., unique and/or particular to any third-party user enhances usability of the system 100 over a broad range of operations and user types.

The output of a monitoring module 108 is a detected condition that is interpreted by the IASMS module 104 to be either adverse or off-nominal to the various monitored systems, supported operations, or associated airspace.

The monitoring module 108 is configured to monitor many parameters including, without limitation, health, performance, and data integrity. Health and performance monitoring are performed using two distinct methods:

The first is simple self-reported fault aggregation, (i.e., faults originating from outside the IASMS). In this case, the IASMS listens to the health, status, and fault reports coming from the component or system being monitored. This is usually the result of internal monitoring capability on the component or system such as built-in-test (BIT). The IASMS assumes that self-reported health issues are accurate and applies them to the internal health state of the component or system. Note that the IASMS does enable other 3rd party systems to indicate that the health of another system is affected or degraded, enabling the ability of additional 3rd party monitoring systems to be used by the IASMS.

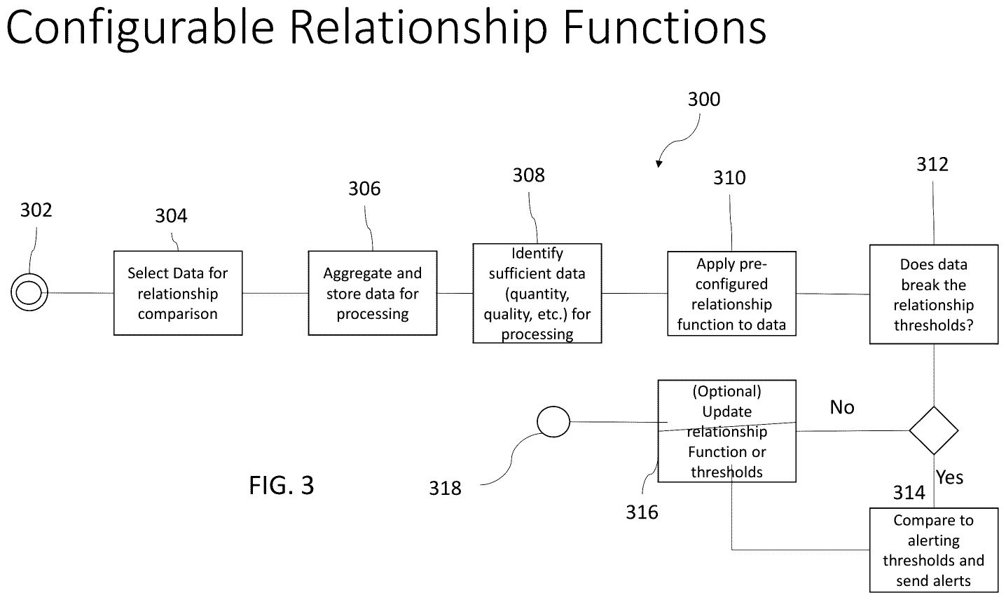

The second method used to monitor the health and performance of various system components is to use data relationships. One exemplary methodology is described in the flow chart 300 depicted in FIG. 3. At least some of the steps in the flow chart of FIG. 3 may be performed by one or more algorithms used for extracting, evaluating, and verifying data relevant to the analysis. In STEP 302, data is obtained from multiple sources which are identified, for example, in association with the instruments and devices identified in FIGS. 1 and 2. In STEP 304, data is selected for a relationship comparison. Selecting of the data is effected via a priori configuration, for example, a priori algorithm, capable of identifying and analyzing data type and the data feed types that are eventually input into a relationship function. In STEP 306, the collected data is aggregated and translated into one or more formats that can be processed by the relationship function(s). This may involve converting the data parameters into common units or reference frames (ex. common altitude coordinate system, propagated to a common time of applicability, etc.). In STEP 308, a determination is made regarding the sufficiency of the volume of data and of data quality. Moreover, this step is a gating function to ensure the results of the relationship functions to which the data are to be subjected are of high quality and accuracy.

With continued reference to the flow chart 300 of FIG. 3, in STEP 310, the preconfigured relationship function is applied to the data. The preconfigured relationship function may use historical, existing, or real-time data or combinations thereof which characterize one or more parameters or operations of the UAS This processing step considers that relationship functions define a relationship between different pieces of data. The relationships may be statistical in nature but could also be based on things such as trends over time. For example, there may be multiple altitude readings available from an aircraft reported in different manners or data streams (including, for example, barometric altitude, GPS altitude, height above ground, etc.). There may not be a direct relationship between a single altitude report from these various sources but reviewing the data over a predetermined period, a determination can be made that the data should all trend in the same direction. For example, if the aircraft is descending, all values should be getting lower. If one of the values is not getting lower, then it may be apparent that the relationship function is broken or is deviated. In STEP 312, a determination is made whether a relationship function has been broken by any data when compared against the pre-configured thresholds. If the result of STEP 312 is “YES”, in STEP 314, the values associated with the deviated data is filtered via one or more filtering functionalities against alert thresholds associated with the data to determine whether an alert should be generated and transmitted. The filtering functionalities may include an M of N type filter where the event needs to occur more than once over some period. STEP 314 is intended to minimize the potential of false alerts; the alert is only transmitted if threshold conditions are satisfied. In this way, only egregious violations of the relationship function will initiate the transmission of an alert in which case minor violations would be filtered out and not cause an alert to be sent. If the result of STEP 312 is “NO”, in STEP 316, an option element of this functionality is the ability for the algorithms to perform unsupervised learning based on the data. This allows them to adjust the relationship function and thresholds over time. Note that to avoid slow drifting problems, this learning function may be turned on and off. In illustrative embodiments, “re-training” may occur at user discretion, intermittingly at predetermined times or time intervals and/or continuously. In STEP 318, the process may be paused.

The methodology described in FIG. 3, requires multiple data points that have some relationship to each other. A change in one data set will have a correlated change to another data set and can therefore be monitored. If the relationship function between two data sets is broken (outside of configurable bounds) then the IASMS determines that one of the two systems providing data is likely experiencing a health or performance issue. By using multiple relationships for each system being monitored, the system having issues may be identified. This technique relies entirely on data available within the ecosystem (e.g., publicly available) and, in illustrative embodiments, does not require onboard SW agents, special HW, or proprietary data about the internal workings of the systems being monitored.

These monitoring methods, when applied to a set of systems or data, constitute a monitoring function module, as depicted in the functional architecture. For example, using these methods on surveillance data, the IASMS can include the deployment of surveillance system monitoring modules. Similarly, applying them to weather sensors, the IASMS can include the deployment of weather system monitoring modules.

With reference again to FIG. 1, another monitoring function performed by the monitoring module 108 includes integrity monitoring. The integrity monitoring may or may not be associated with the same monitoring module 108. The IASMS monitors data integrity of multiple data streams using a configurable Data Integrity Monitoring Service. This service uses a schema to identify the data characteristics to monitor for an individual data stream. A different schema may be used for every data stream or interface. The configurable schema contains parameters needed to monitor data characteristics which may be used to infer integrity using a filter to limit false alerts. The integrity of data may be based in part on data completeness, bounds, data message rates, and rate of change within the data field values.

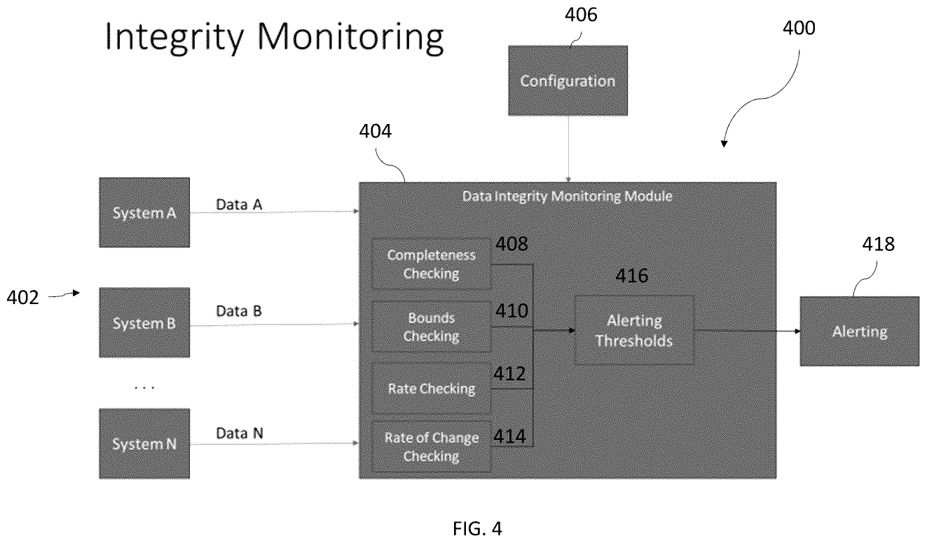

FIG. 4 is a block diagram 400 further illustrating the integrity monitoring functionality associated with the system 100. In BLOCK 402, external systems A, B, C which send data streams to the IASMS may, in illustrative embodiments, undergo data integrity monitoring. Generally, this function is performed on data coming from a sensor, or “detected,” or is periodic in nature. In BLOCK 404, the data integrity monitoring module or functionality consists of a collection of tests run against data, described in a schema. The schema is fed in through the configuration service of BLOCK 406. The schema defines the “passing criteria” for each test run against the data and contains things like thresholds, rates of change, and message timing. The schema may be configured by an authorized user, or it may be constructed from historical data. It may be re-loaded at any time, enabling the system to learn if changes in the data necessitate a schema change. At BLOCK 408, the data completeness check verifies that all the required fields of the data are present in the incoming data message. It makes sure the data is, for example, properly typed (e.g., a floating-point number is not represented as an integer). At BLOCK 410, the bounds checking function verifies that no parameter of the data is outside of the bounds set in the schema for that parameter. At BLOCK 412, the message rate checking function verifies that the message is coming in at a rate that is within the bounds set in the schema. For instance, if a periodic message is set to be sent every second, the schema might define a valid rate as every second plus or minus some time to account for latency. At BLOCK 414, the rate of change function maintains a historical record of each parameter and looks at the rate of change of that parameter over time. This function is generally configured to act on parameters that represent or describe a real physical object. For example, an airplane may be able to travel at hundreds of knots, so a value of 500 knots would not fall outside of the bounds of the field and would not trigger the test in 106. However, if the previous speed was 100 knots and was reported 2 seconds earlier, the data would likely trigger the rate of change test as it is outside of the plane's performance envelope to accelerate 400 knots in 2 seconds. At BLOCK 416, to minimize false alerts, there may be a pre-configured filter of thresholds that alerts must pass through to trigger an alert being sent from the system. This filter may be an M of N type filter where the event needs to occur more than once over some period. Alternatively, the filter may be configured to cover only egregious violations of a test in which case minor violations would be filtered out and not cause an alert to be sent by the alerting function (BLOCK 418) which is responsible for distributing alerts to systems which are interested.

Referring again to FIG. 1, the IASMS module further includes an impact assessment function 110. This IASMS function attempts to determine the impact of detected issues within the ecosystem. It is generally looking at the impact from a high level to understand what airspace, operations, or systems are affected. To choose an appropriate mitigation response or contingency management procedure, the extent of the impact must be known. In particular, multiple detected events occurring simultaneously may result in a different impact than each one happening in isolation. This function assesses the aggregate impact due to the current state of the ecosystem to better inform decisions (human or automated) about what to do about the current situation.

With continued reference to FIG. 1, the IASMS module further includes a mitigation module 112. If conditions are detected and assessed to have a safety impact on the ecosystem, then the IASMS will determine a mitigation strategy. Mitigations are designed to maintain safety, uptime, and availability while decreasing disruption and uncertainty. Safety, however, is highly significant in determining the mitigation strategy.

Mitigations may be presented as options to a human or selected by an artificial intelligence (AI) system. The mitigation selection function determines what available mitigations are available based on the state of the ecosystem. Available mitigations are shown in the next block “Mitigation Functions.”

This function prioritizes mitigation options given configurable prerogatives. The IASMS enables configuration of whether mitigations are presented to a user at a granular level, enabling a mix of automated and human in the loop interactions.

The IASMS does not control any aircraft. In illustrative embodiments, a mitigation does not directly involve controlling the performance or functioning of an aircraft.

Mitigations generally take the form of alerts or constraints within a managed UAS ecosystem. There is assumed to be a UAS operator or higher level UTM system which interprets the IASMS output and adjusts operations if necessary to maintain safety. Note that a mitigation with control authority over systems, services, or data may be registered with the IASMS and subsequently triggered. Once triggered, registered mitigations extend outside of the IASMS functional boundary. For example, a pre-defined mitigation may be “if scenario A happens, tell the Ground Control Station (GCS) to initiate a descend maneuver.” The IASMS does not descend (control) the aircraft, it simply tells the GCS to activate a pre-defined risk mitigation technique. In illustrative embodiments, a mitigation does not involve control of the unmanned vehicle nor suspension or shut down of the system.

Referring again to FIG. 1, another module of the IASMS 104 includes a precursor, anomaly, and trend (PAT) module 114. The PAT module 114 functionality looks at past and current events to determine if there may be a future problem. This prognostic capability runs over historical data sets and usually does not provide alerts with the same latency as the real-time monitoring functions. For example, and without limitation, the PAT module 114 may notice that historically a thunderstorm in a particular area affects surveillance accuracy of a sensor. It may alert the ecosystem that a forecast thunderstorm in the future may affect system performance, enabling operators to plan ahead (rather than reacting to a real-time detection of loss in performance). The PAT module 114 uses both analytical and Machine Learning (ML) approaches (e.g., algorithms) to find patterns across disparate events or data sets. Many other weather conditions may be reviewed, monitored and analyzed by the PAT module 114 to initiate an alert to the ecosystem.

The entire IASMS architecture 104 is built to be highly modular and configurable. The modules included for a specific IASMS deployment depend on the various components and associated elements in use by the UAS ecosystem. Also, the number and overlap of various sensors may enable additional modules to be used that would not otherwise be possible in other deployments. The individual data collectors and external interfaces are modular. The Monitoring Functions which run on the data are modular. The Mitigation Functions are also modular.

Within each module there may exist elements that are configurable. This enables flexibility by assuming that not all data for every system or deployment follow the same rules and therefore takes advantage of abilities to learn and customize the rules for an individual UAS ecosystem. Information about which modules to use and how to configure them is read into the IASMS from configuration files at start-time but may also be updated during run-time by re-loading the configuration.

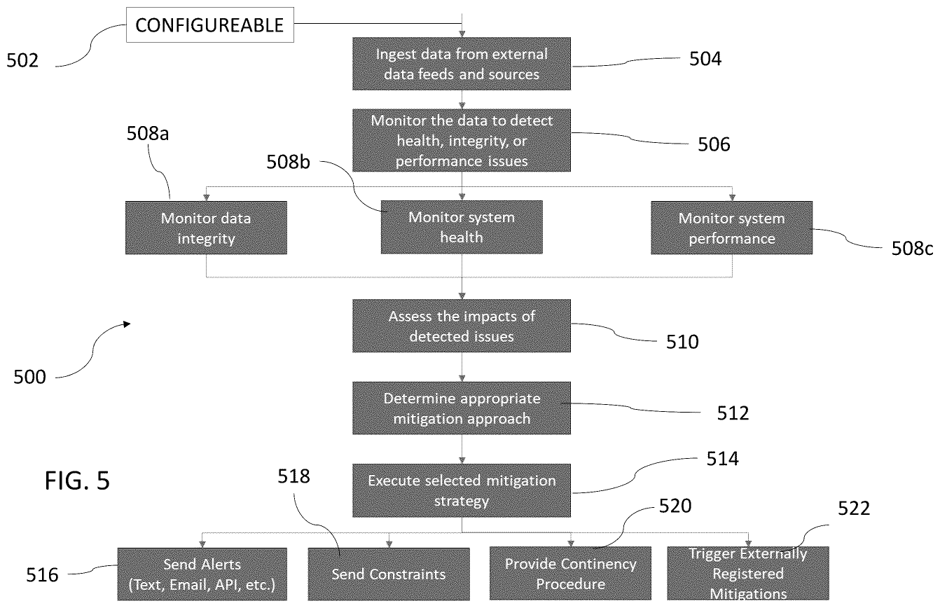

FIG. 5 is a flow chart 500 illustrating one methodology for establishing real-time safety assurance solutions for highly automated and autonomous ecosystems in accordance with the principles of the present invention. In STEP 502, the IASMS is configured. This configuration is a result of the IASMS reading in a configuration file and disturbing relevant configuration parameters and data to the appropriate algorithms, functions, or services. The original configuration file may be human or machine generated outside of the context of the IASMS, although IASMS services may inform dynamic configuration parameters. STEP 504 involves the ingestion of data from external data feeds and sources. STEP 506 involves the monitoring processes discussed hereinabove. The monitoring processes include monitoring data integrity STEP 506a, monitor system health STEP 506b and monitor system performance STEP 506c. Thereafter, the impact(s) of detected issues is analyzed (STEP 508). In STEP 510, the appropriate mitigation approaches are determined (STEP 512) and the selected mitigation strategy is executed (STEP 514). The mitigation strategies include, but are not limited to: sending alerts (STEP 516), sending constraints (STEP 518), providing continency procedure alerts (STEP 520) and/or triggering externally registered mitigations (STEP 522).

In illustrative embodiments, the monitoring modules include, for example and without limitation, as follows:
WSDM—Weather Sensor Data Monitoring service which compares data between various weather sensors to determine if they are healthy.
Data Integrity Service—This service runs on streaming data to determine if the data has any quality issues. It looks at data over time and is configurable to any JSON data format. Non-JSON data formats can be preprocessed into JSON if needed.
Surveillance Sensitivity Monitoring Service—This service compares data from multiple surveillance sensors to determine if sensors with associated coverage volumes have sensitivity or detection issues.

Interface Modules include:

These modules used with the IASMS translate data from 3rd party data message sources to common formats used within the IASMS.

### Mitigation Modules

Alerting Module sends for example, and without limitation, alerts out to both human and machine recipients via text messaging, email, and data messages depending on how it is configured. This module includes functionality that allows users to subscribe to alerts based on a set of criteria.
Constraint Generation—If a detected condition is assessed to affect an airspace region, this module generates a 3D or 4D airspace volume with additional meta-data and sends it to the appropriate external systems.

Additional capabilities of the IASMS architecture include “modules” or “services” such as a Weather Sensor Data Monitoring (WSDM) Service, Surveillance Sensor Sensitivity Monitoring Service, Dynamic, Real-time Aviation Risk Assessment Service and Battery Estimator based on Wind Energy Efficiency (BE-WindEE). These include but are not limited to all the systems and data described herein. The IASMS methodology, and computer program product platform may be applied and/or utilized in a variety of real-world environments and applications.

Embodiments of the present invention include a system, a method, and/or a computer program product at any possible technical detail level of integration. The computer program product may include a computer readable storage medium (or media) having computer readable program instructions thereon for causing a processor to conduct aspects of the present invention.

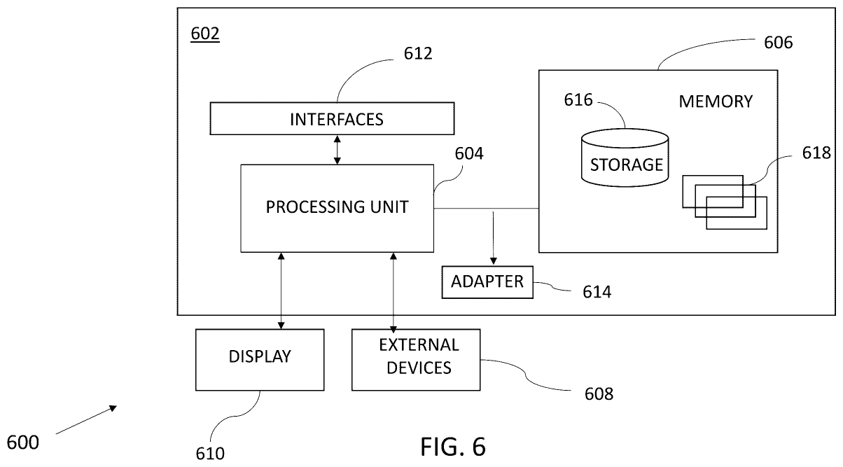

With reference to FIG. 6, one or more embodiments of the present invention may be executed on software running on a computer node or workstation. The computer node 600 includes a computer system/server 602, which is operational with numerous other computing system environments. The computer system/server 602 in computing node 600 is shown in the form of a general-purpose computing device. The computer system/server 602 may include, and or be associated with, without limitation, one or more processors or processing units 604 and a system memory 606 coupled to the one or more processing units 604.

The computer system/server 602 may also communicate with one or more external devices 608 such as a keyboard, a pointing device, a display 610, etc., one or more devices that enable a user to interact with computer system/server 602, and/or any devices (e.g., network card, modem, etc.) that enable computer system/server 602 to communicate with one or more other computing devices. Such communication can occur via/O interfaces 612. Still yet, computer system/server 602 can communicate with one or more networks such as a LAN, a general WAN, and/or a public network (e.g., the Internet) via network adapter 614. As depicted, network adapter 614 communicates with the other components of computer system/server 602. It should be understood that although not shown, other hardware and/or software components could be used in conjunction with computer system/server 602. The computer system/server 602 may further include other removable/non-removable. volatile/nonvolatile computer system storage or media 616. The computer system/server 602 includes one or more engines or modules 618 that include routines, programs, objects, components, logic, data structures, and so on that perform particular tasks or implement particular abstract data types.

The computer system/server 602 may be practiced in distributed cloud computing environments where tasks are performed by remote processing devices that are linked through a communications network. In a distributed cloud computing environment, program modules may be located in both local and remote computer system storage media including memory storage devices.

Examples of well-known computing systems suitable for use with computer system/server 602 include, but are not limited to, personal computer systems, server computer systems, handheld or laptop devices, multiprocessor systems, microprocessor-based systems, network PCs, mainframe computer systems, mobile and wearable devices, and distributed cloud computing environments that include any of the above systems or devices, and the like.

The computer readable storage medium 616, and can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more program code languages, including an object oriented program code language such as Python, C++, or the like, and procedural program code languages, such as the “C” program code language or similar program code languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform to conduct the functions of embodiments of illustrative embodiments herein. In illustrative embodiments, the computer readable program instructions may be embodied in one or more program modules.

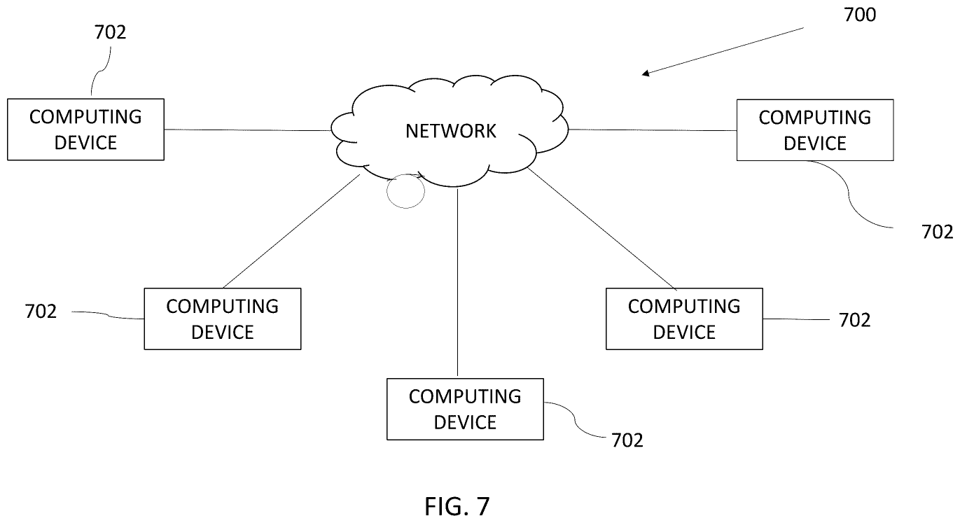

FIG. 7 illustrates a distributed communications/computing network (processing platform) in accordance with which one or more embodiments of the invention can be implemented. By way of illustration, FIG. 7 depicts a communication system 700 that includes a plurality of computing devices 702-1 through 702-P (herein collectively referred to as computing devices) configured to communicate with one another over a network 702. Any of the aforementioned communication devices may be utilized in the communication system 700. The network 702 may include, for example, a global computer network such as the Internet, a wide area network (WAN), a local area network (LAN), a satellite network, a telephone or cable network, or various portions or combinations of these and other types of networks (including wired and/or wireless networks).

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or conduct combinations of special purpose hardware and computer instructions.

The present invention is not to be limited in scope by the specific embodiments described herein. Indeed, various modifications of the invention in addition to those described herein will become apparent to those skilled in the art from the foregoing description. Such modifications are intended to fall within the scope of the appended claims.

While embodiments of the present disclosure have been particularly shown and described with reference to certain examples and features, it will be understood by one skilled in the art that various changes in detail may be effected therein without departing from the spirit and scope of the present disclosure as defined by claims that can be supported by the written description and drawings. Further, where exemplary embodiments are described with reference to a certain number of elements it will be understood that the exemplary embodiments can be practiced utilizing either less than or more than the certain number of elements.

All references cited herein are incorporated herein by reference in their entirety and for all purposes to the same extent as if each individual publication, patent, or patent application was specifically and individually indicated to be incorporated by reference in its entirety for all purposes.

The citation of any publication is for its disclosure prior to the filing date and should not be construed as an admission that the present invention is not entitled to antedate such publication by virtue of prior invention.

What is claimed is:

1. A method, comprising:
ingesting data from external data feeds and sources in association with performance of an uncrewed aviation ecosystem;
monitoring the data;
detecting one or more issues associated with the at least one of health, integrity, or performance issues associated with the data or associated systems;
assessing impact of the one or more issues with respect to the uncrewed aviation ecosystem;
determining one or more mitigation strategies to address the impact of the one or more issues; and
executing the one or more mitigation strategies;
wherein the steps are performed by at least one processing device comprising a processor operatively coupled to a memory.

2. The method of claim 1 wherein one or more steps are configured for a specific deployment at system startup with the ability to be reconfigured during runtime through the execution of a manual or automated configuration refresh command.

3. The method of claim 1 wherein executing the one or more mitigation strategies includes at least one of sending an alert, sending a constraint, providing a contingency procedure, and triggering an external registered mitigation action.

4. The method of claim 3 wherein executing the one or more mitigation strategies is automatically performed.

5. The method of claim 3 wherein executing the one or more mitigation strategies is devoid of directly controlling performance of the uncrewed vehicle.

6. The method of claim 1 including determining one or more trends associated with the data, the one or more trends facilitating detection of the one or more issues.

7. The method of claim 6 wherein the one or more trends include historic trends.

8. The method of claim 1 wherein monitoring the data includes collecting data from at least one of communications systems, surveillance systems, navigation systems, weather sensing systems, and digital infrastructure systems associated with the unmanned vehicle.

9. The method of claim 1 wherein detecting one or more issues comprises evaluating one of completeness, bounds, rate, and rate of change associated with the data;

10. A system, comprising:
at least one processor, coupled to a memory, and configured to:
ingest data from external data feeds and sources in association with performance of an uncrewed aviation ecosystem;
monitor the data;
detect one or more issues associated with the at least one of health, integrity, or performance issues associated with the data or associated systems;
assess impact of the one or more issues with respect to the uncrewed aviation ecosystem;
determine one or more mitigation strategies to address the impact of the one or more issues; and
execute one or more mitigation strategies.

11. A computer program product comprising a non-transitory processor-readable storage medium having stored therein program code of one or more software programs, wherein the program code, when executed by at least one processing device comprising a processor coupled to a memory, causes the at least one processing device to:
ingest data from external data feeds and sources in association with performance of an uncrewed aviation ecosystem;
monitor the data;
detect one or more issues associated with the at least one of health, integrity or performance issues associated with the data or associated systems;
assess impact of the one or more issues with respect to the uncrewed aviation ecosystem;
determine one or more mitigation strategies to address the impact of the one or more issues; and
execute one or more mitigation strategies.
